(19) United States
(12) Patent Application Publication
(10) Pub. No.: US 2020/0356188 A1
(43) Pub. Date: Nov. 12, 2020

(54) SIMPLIFIED SPECIAL-PURPOSE ACTIVE CAPACITIVE PEN MODULE

(71) Applicant: Ling Huang, Luoding (CN)

(72) Inventor: YUERONG WU, HEYUAN (CN)

(73) Assignee: LING HUANG

(21) Appl. No.: 16/823,474

(22) Filed: Mar. 19, 2020

(30) Foreign Application Priority Data
May 9, 2019 (CN) 201920659601.1

(51) Int. Cl. G06F 3/0354; G06F 3/044; G06F 3/038

(52) U.S. Cl. CPC G06F 3/03545; G06F 3/0383; G06F 3/044

(57) ABSTRACT

The utility model discloses a simplified special-purpose active capacitive pen module, which belongs to the technical field of electronic capacitive pen. It solves the problem of large writing offset and low accuracy and the problem of hand interference with pen signal, simplifies the structure of the original special-purpose capacitive pen, and greatly reduces the production cost. The pen core constructed by the utility model adopts a transmitting core.

### CROSS-REFERENCE TO RELATED APPLICATIONS

This application claims priority to Chinese Patent Application No. 201920659601.1 with a filing date of May. 9, 2019. The content of the aforementioned application, including any intervening amendments thereto, are incorporated herein by reference.

### FIELD OF TECHNOLOGY

The utility model gets involved in the technical field of electronic capacitive pen, a simplified special-purpose active capacitive pen module in particular.

### BACKGROUND

Capacitive pen is a pen made of conductor materials, which is conductive and used to touch the capacitive screen to complete the human-computer conversation. It is an auxiliary device which imitates human body (usually fingers) through conductor materials to complete the human-computer conversation. With the development of APPs, the current capacitive pen is no longer simply replace fingers to operate, but more and more professionals have tried the active capacitive pen to work on mobile devices. At present, the existing special-purpose capacitive pen available in the market is characterized by complex structure and high cost, making it expensive and not conducive to promotion.

### CONTENTS OF THE UTILITY MODEL

The purpose of the utility model is to provide a simplified special-purpose active capacitive pen in order to make up the insufficiency and shortcomings of the existing technology. It adopts specified signal source, so that high-precision writing can be achieved on the specified device, which eliminates writing offset. Moreover, hands can also be placed directly on the screen without affecting pen signal, which greatly restores original handwriting. By removing the tilt function which is not commonly used can also effectively simplify the internal structure and greatly reduce the production cost, thus lowering the price.

In order to achieve the above purpose, the utility model applies the following technical plan:

The special-purpose active capacitive pen module is composed of the upper support, lower support, signal circuit board, transmitting spring, transmitting core, insulating sleeve, conductive pen head, metal tube and metal bevel. The signal circuit board is installed between the upper and lower supports. The signal circuit board is electrically connected with the transmitting spring, which is electrically connected with the transmitting core. One end of the transmitting core is constructed with an elastic chuck, which can clamp the conductive pen head to form an electrical connection. The end of the transmitting core is covered with an insulating sleeve. The upper and lower supports are provided with a metal tube, which is electrically connected with the ground spring piece on the signal transmitting board. The metal beveled head is screwed on the thread of the upper and lower supports through thread, and the bottom of the metal beveled head is electrically connected with the metal tube.

To sum up, the implementation plan of the utility model has the following beneficial effects compared with the existing technology:

The utility model applies reasonable design and adopts specified signal source, so that high-precision writing can be achieved on the specified device, which eliminates writing offset. Moreover, hands can also be placed directly on the screen without affecting pen signal, which greatly restores original handwriting, and minimizes the production cost.

### DESCRIPTION FOR FIGURES

In order to explain the implementation plan of the utility model or the technical scheme in the existing technology more clearly, the following attached figures for the implementation plan or existing technical scheme are displayed for the simple introduction. Obviously, the following figures are only some of the implementation plans of the utility model. For common technicians of the area, they can acquire the other figures according to the existing ones under the premise of not paying any creativity or labor.

FIG. 1 is the structural diagram of the implementation plan of the utility model.

FIG. 2 is the structural diagram for the installation of upper and lower supports in the implementation plan of the utility model.

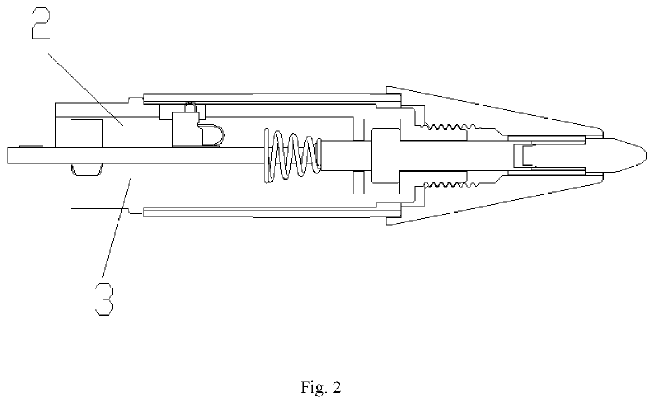

FIG. 3 is the structural diagram of the transmitting core module in the implementation plan of the utility model.

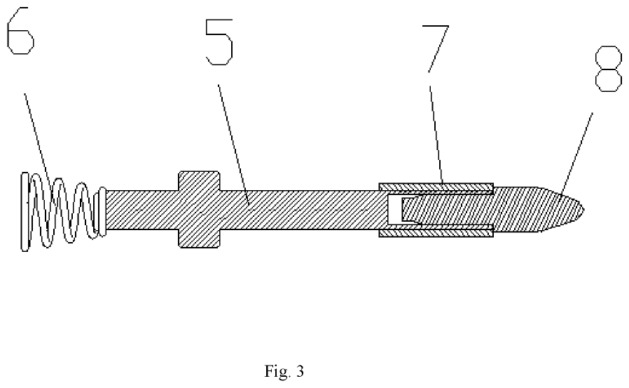

FIG. 4 is the structural diagram of the transmitting core in the implementation mode of the utility model.

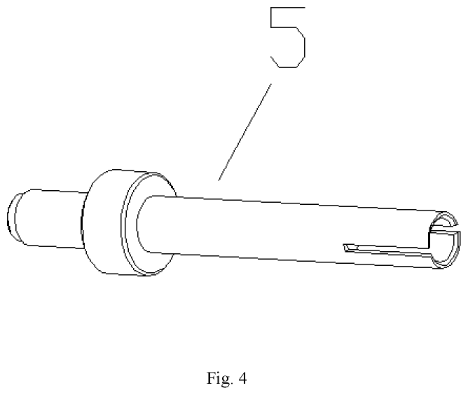

FIG. 5 is the structural diagram of the conductive pen head in the implementation mode of the utility model.

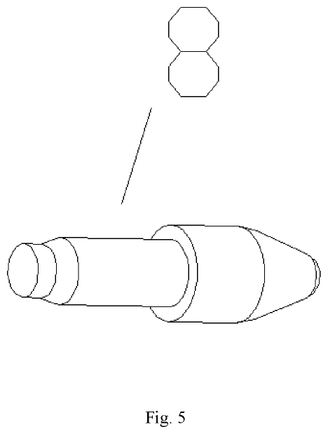

FIG. 6 is the structural diagram of the transmitting spring in the implementation mode of the utility model.

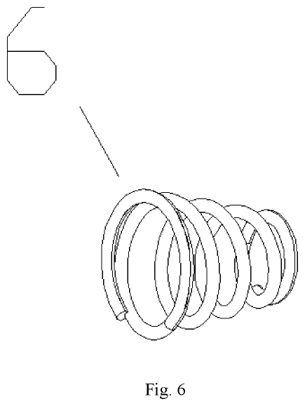

FIG. 7 is the structural diagram of the insulating sleeve in the implementation mode of the utility model.

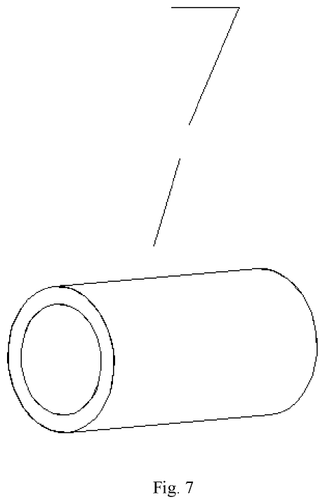

FIG. 8 is the structural diagram of the metal bevel in the implementation mode of the utility model.

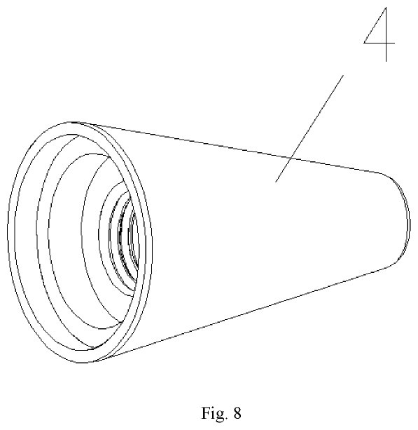

FIG. 9 is the structural diagram of the metal tube in the implementation mode of the utility model.

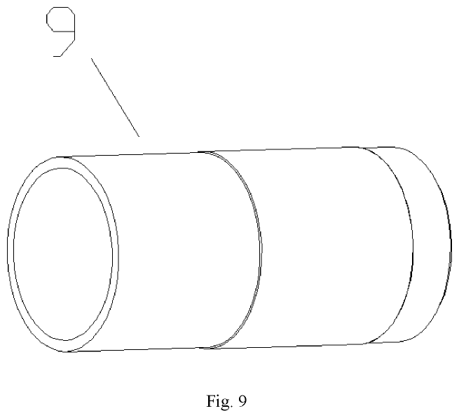

FIG. 10 is the structural diagram of the lower support in the implementation mode of the utility model.

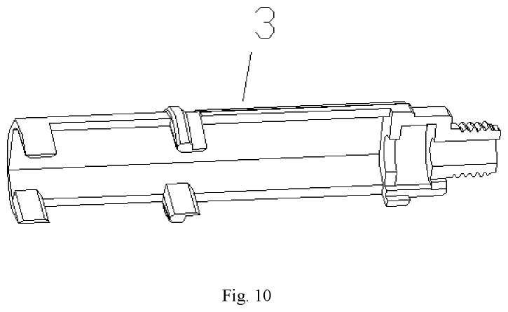

FIG. 11 is the structural diagram of the upper support in the implementation mode of the utility model.

Description of the marks of the figures: 1-signal circuit board, 2-upper support, 3-lower support, 4-metal bevel, 5-transmitting core, 6-transmitting spring, 7-insulating sleeve, 8-conductive pen head and 9-metal tube.

### SPECIFIC IMPLEMENTATION MODE

The technical scheme of the utility model will be further described in combination with the attached figures and specific implementation plans.

Implementation Plan 1

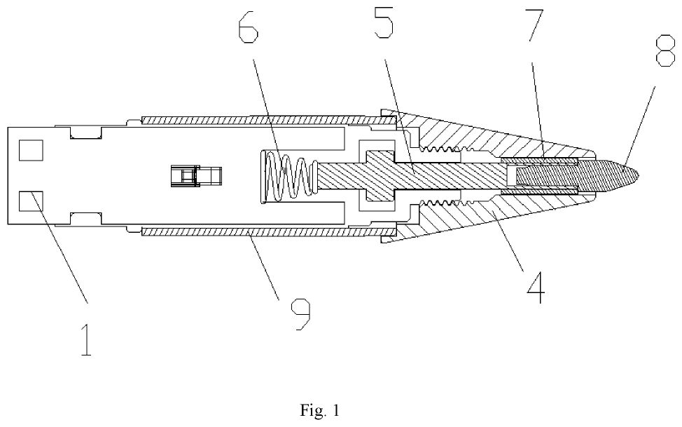

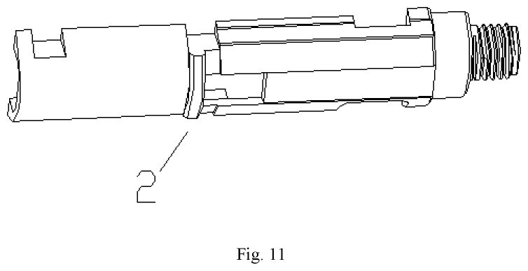

As shown in FIG. 1˜FIG. 11, the special-purpose active capacitive pen module is composed of the upper support 2, lower support 3, signal circuit board 1, transmitting spring 6, transmitting core 5, insulating sleeve 7, conductive pen head 8, metal tube 9 and metal bevel 4. The signal circuit board 1 is installed between the upper support 2 and the lower support 3. The signal circuit board 1 is electrically connected with the transmitting spring 6, which is electrically connected with the transmitting core 5. One end of the transmitting core 5 is constructed with an elastic chuck, which can clamp the conductive pen head 8 to form an electrical connection. The end of the transmitting core 5 is covered with an insulating sleeve 7. The upper support 2 and the lower support 3 are provided with a metal tube 9, which is electrically connected with the ground spring piece on the signal transmitting board 1. The metal beveled head 4 is screwed on the thread of the upper support 2 and the lower support 3 through thread, and the bottom of the metal beveled head 4 is electrically connected with the metal tube 9.

The operating principle of the utility model is that it is constructed with a transmitting core. Specifically, a specific signal is sent out through the signal circuit board 1, which is transmitted to the transmitting core 5 through the transmitting spring electrically connected on the circuit end pin, and then transmitted to the conductive pen head for signal transmission through the transmitting core 5. The signal can be identified by the specified device. When the specified device identifies the signal, it will immediately stop the signal sent out by the device screen, and the screen will change to the mode of high-precision receipt signal. As the screen has stopped sending out the signal, hand signal will not be identified, and hands will not interfere with the use of the pen.

The ground spring of the signal circuit board 1 passes through the upper support 2 to electrically contact the metal tube 9, and the metal bevel 4 is screwed to contact the metal tube 9, so that the ground spring of the signal circuit board 1 and the metal bevel 4 are in the grounded state, the signal sent out by the conductive pen head 8 has a ground reference value, and the signal circuit board sends out an effective signal.

The utility model applies reasonable design and adopts specified signal source, so that high-precision writing can be achieved on the specified device, which eliminates writing offset. Moreover, hands can also be placed directly on the screen without affecting pen signal, which greatly restores original handwriting. By removing the tilt function which is not commonly used can also effectively simplify the internal structure and greatly reduce the production cost, thus lowering the price.

The technical principle of the utility model is described above in combination with specific implementation plans, which are only the preferred implementation modes of the utility model. The protection scope of the utility model is not limited to the above implementation plans, and all technical schemes under the idea of the utility model fall within the protection scope of the utility model. For technicians of the area, they can associate with other implementation plans of the utility model without paying any creativity or labor. These plans will also fall within the protection scope of the utility model.

Specifically, the signal circuit board is installed between the upper and lower supports, the signal circuit board is electrically connected with the transmitting spring, and the electrical spring is electrically connected with the transmitting core. One end of the transmitting core is constructed with an elastic chuck, which can clamp the conductive pen head to form an electrical connection, the end of the transmitting core is covered with an insulating sleeve. The upper and lower supports are provided with a metal tube, which is electrically connected with the ground spring piece on the signal transmitting board. The metal beveled head is screwed on the thread of the upper and lower supports through thread, and the bottom of the metal beveled head is electrically connected with the metal tube. With specified signal source, high-precision writing can be achieved on the specified device, which eliminates writing offset, and hands can also be placed directly on the screen without affecting pen signal, which greatly restores original handwriting. However, due to the simplified structure, the device cannot identify pen bevel and trigger the corresponding function.

We claim:

1. The special-purpose active capacitive pen module is comprising: the upper support (2), lower support (3), signal circuit board (1), transmitting spring (6), transmitting core (5), insulating sleeve (7), conductive pen head (8), metal tube (9) and metal beveled head (4);
wherein, the signal circuit board (1) is installed between the upper support (2) and the lower support (3);
wherein, the signal circuit board (1) is electrically connected with the transmitting spring (6), and the electrical spring (6) is electrically connected with the transmitting core (5);
wherein, one end of the transmitting core (5) is constructed with an elastic chuck, which can clamp the conductive pen head (8) to form an electrical connection;
wherein, the end of the transmitting core (5) is covered with an insulating sleeve, the upper support (2) and lower support (3) are provided with a metal tube (9), which is electrically connected with the ground spring piece on the signal transmitting board (1);
wherein, the metal beveled head (4) is screwed on the thread of the upper support (2) and lower support (3) through thread, and the bottom of the metal beveled head (4) is electrically connected with the metal tube (9).
